(19) United States
(12) Patent Application Publication
(10) Pub. No.: US 2011/0264373 A1
(43) Pub. Date: Oct. 27, 2011

(54) Method For The Management of Oilfields Undergoing Solvent Injection

(76) Inventors: Owen J. Hehmeyer, Houston, TX (US); Robert D. Kaminsky, Houston, TX (US)

(21) Appl. No.: 13/032,293

(22) Filed: Feb. 22, 2011

(30) Foreign Application Priority Data
Apr. 26, 2010 (CA) 2,701,422

(51) Int. Cl. E21B 47/10; G06F 19/00

(52) U.S. Cl. 702/13; 73/152.39

(57) ABSTRACT

Solvent-dominated hydrocarbon recovery processes use chemical solvent(s), rather than a heat-transfer agent, as the principal means to achieve hydrocarbon viscosity reduction. Such processes are fundamentally different from thermally-dominated recovery processes and have unique challenges. Field measurements described herein, such as the rate of solvent production, can be used to manage solvent-dominated hydrocarbon recovery processes, for instance for improving hydrocarbon recovery or solvent efficiency.

### CROSS REFERENCE TO RELATED APPLICATIONS

This application claims priority from Canadian Patent Application 2,701,422 filed Apr. 26, 2010 entitled A METHOD FOR THE MANAGEMENT OF OILFIELDS UNDERGOING SOLVENT INJECTION, the entirety of which is incorporated by reference herein.

### FIELD OF THE INVENTION

The present invention relates generally to in-situ hydrocarbon recovery, including viscous oil. More particularly, the present invention relates to the management of an oil field undergoing solvent injection.

### BACKGROUND OF THE INVENTION

Solvent-dominated in-situ oil recovery processes are those in which chemical solvents are used to reduce the viscosity of the in-situ oil. A minority of commercial viscous oil recovery processes use solvents to reduce viscosity. Most commercial recovery schemes rely on thermal methods such as Cyclic Steam Stimulation (CSS, see, for example, U.S. Pat. No. 4,280,559) and Steam-Assisted Gravity Drainage (SAGD, see, for example U.S. Pat. No. 4,344,485) to reduce the viscosity of the in-situ oil. As thermal recovery technology has matured, practitioners have added chemical solvents, typically hydrocarbons, to the injected steam in order to obtain additional viscosity reduction. Examples include Liquid Addition to Steam For Enhancing Recovery (LASER, see, for example, U.S. Pat. No. 6,708,759) and Steam And Vapor Extraction processes (SAVEX, see, for example, U.S. Pat. No. 6,662,872). These processes use chemical solvents as an additive within an injection stream that is steam-dominated. Solvent-dominated recovery processes are a possible next step for viscous oil recovery technology. In these envisioned processes, chemical solvent is the principal component within the injected stream. Some non-commercial technology, such as Vapor Extraction (VAPEX, see, for example, R. M. Butler & I. J. Mokrys, J. of Canadian Petroleum Technology, Vol. 30, pp. 97-106) and Cyclic Solvent-Dominated Recovery Process (CSDRP, see, for example, Canadian Patent No. 2,349,234) use injectants that may be 100%, or nearly all, chemical solvent.

At the present time, solvent-dominated recovery processes (SDRPs) are rarely used to produce highly viscous oil. Highly viscous oils are produced primarily using thermal methods in which heat, typically in the form of steam, is added to the reservoir. Cyclic solvent-dominated recovery processes (CSDRPs) are a subset of SDRPs. A CSDRP is typically, but not necessarily, a non-thermal recovery method that uses a solvent to mobilize viscous oil by cycles of injection and production. Solvent-dominated means that the injectant comprises greater than 50% by mass of solvent or that greater than 50% of the produced oil's viscosity reduction is obtained by chemical solvation rather than by thermal means. One possible laboratory method for roughly comparing the relative contribution of heat and dilution to the viscosity reduction obtained in a proposed oil recovery process is to compare the viscosity obtained by diluting an oil sample with a solvent to the viscosity reduction obtained by heating the sample.

In a CSDRP, a viscosity-reducing solvent is injected through a well into a subterranean viscous-oil reservoir, causing the pressure to increase. Next, the pressure is lowered and reduced-viscosity oil is produced to the surface through the same well through which the solvent was injected. Multiple cycles of injection and production are used. In some instances, a well may not undergo cycles of injection and production, but only cycles of injection or only cycles of production.

CSDRPs may be particularly attractive for thinner or lower-oil-saturation reservoirs. In such reservoirs, thermal methods utilizing heat to reduce viscous oil viscosity may be inefficient due to excessive heat loss to the overburden and/or underburden reservoir with low oil content.

References describing specific CSDRPs include: Canadian Patent No. 2,349,234 (Lim et al.); G. B. Lim et al., “Three-dimensional Scaled Physical Modeling of Solvent Vapour Extraction of Cold Lake Bitumen”, The Journal of Canadian Petroleum Technology, 35(4), pp. 32-40, April 1996; G. B. Lim et al., “Cyclic Stimulation of Cold Lake Oil Sand with Supercritical Ethane”, SPE Paper 30298, 1995; U.S. Pat. No. 3,954,141 (Allen et al.); and M. Feali et al., “Feasibility Study of the Cyclic VAPEX Process for Low Permeable Carbonate Systems”, International Petroleum Technology Conference Paper 12833, 2008.

The family of processes within the Lim et al. references describe embodiments of a particular SDRP that is also a cyclic solvent-dominated recovery process (CSDRP). These processes relate to the recovery of heavy oil and bitumen from subterranean reservoirs using cyclic injection of a solvent in the liquid state which vaporizes upon production. The family of processes within the Lim et al. references may be referred to as CSP™ processes.

### Key Differences Between Thermal and Solvent-Dominated Recovery Processes

A key difference between a thermal recovery process and a SDRP is the value of the injected fluid. Solvent, such as hydrocarbon solvent, is more valuable than crude oil or steam. Therefore, fundamentally different approaches of measurement and analysis are required. Whereas in a steam-based process, measurement of temperature and injected volumes are important, in a solvent-dominated process, measurements of temperature are important largely for hydrate prevention, not viscosity reduction. Temperature may also be used to control the phase of the injectant. Measurements of produced solvent are important for maximizing solvent efficiency and solvent recovery.

Another key difference between thermal recovery processes and SDRPs is that heat may conduct through solids, whereas solvent may not. Solvent must be transported via flow through porous rock. Although monitoring of steam is important for understanding heat distribution, oil may flow even though steam has not directly contacted it. However, in a SDRP, viscous oil typically does not flow at a reasonable rate unless it has been mixed with solvent.

Another key difference between thermal recovery processes and SDRPs is the cost of fluid storage. In thermal processes, hot water is produced as at least a portion of the injected steam condenses underground and is produced back to the surface with oil. In a SDRP, the solvent must be compressed after production and stored locally at great cost if there is no injection capacity available. Measurement and analysis systems aimed at solvent storage reduction are important to making a SDRP economic.

### Limitations of Prior Descriptions

Much of the research and patent literature that discusses viscous oil recovery processes focus on idealized processes as if they would be carried out for a single well, and does not discuss how to practically operate a SDRP at field scale to achieve certain efficiencies. Field scale operation demands that the key differences between thermal recovery processes and SDRPs be addressed using practical measurement and processes.

### Solvent-Dominated Process Literature

U.S. Pat. No. 3,954,141 to Allen et al. entitled “Multiple Solvent Heavy Oil Recovery Method” offers a “Field Example” (col. 7, line 30) of the process, but nowhere within that example does the patent discuss the measurement of properties of the process, such as solvent production rate, for the digital management of the oilfield, such as increasing oil production or solvent efficiency.

Upreti et al. (Energy & Fuels 2007, 21, 1562-1574) wrote an up-to-date review article discussing the current state of understanding of Vapor Extraction (VAPEX), by far the most-studied SDRP. Upreti et. al. do not discuss the measurement of properties of the process, such as solvent production rate, for the digital management of the oilfield, such as increasing oil production or solvent efficiency.

Additional patents that disclose methods for the recovery of viscous oil using SDRPs include: U.S. Pat. No. 6,883,607 (Nenniger et al.); U.S. Pat. No. 6,318,464 (Mokrys); U.S. Pat. No. 5,899,274 (Frauenfeld et al.); and U.S. Pat. No. 4,362,213 (Tabor). These patents do not discuss methods for the digital management of oilfields undergoing solvent injection.

### Digital Management of Oilfields

The digital management of oilfield operations is discussed in certain patent documents. These patents tend to fall generally into two groups—those that focus on digital methods and apparatus as a central aspect of the invention and provide examples of the method and apparatus being customized for a particular problem or class of problems; and those that focus on solving a specific problem and preferably, but not necessarily, employ digital oilfield apparatus.

Ramakrishnan et al. (U.S. Pat. No. 7,096,092) is one example of the first type. Ramakrishnan et al. discloses, “Methods and Apparatus for Remote Real Time Oil Field Management”. For example, they envision an apparatus comprising program modules for (FIG. 1) “analysis, alarm/message, acknowledgement, controller, and event logged.” Nowhere within Ramakrishnan et al. are SDRPs discussed or how their apparatus or any other particular apparatus for remote real time oil field management might be used to maximize oil recovery or otherwise improve an SDRP.

European Patent Document No. 1,355,169 to Baker Hughes Inc. entitled “Method and Apparatus for Controlling Chemical Injection of a Surface Treatment System,” ('169) is exemplary of the second kind. That patent document envisions sensors in the oil field whereby (col. 5, line 46) “the distributed sensors of this invention find particular utility in the monitoring and control of various chemicals which are injected into the well. Such chemicals are needed downhole to address a large number of known problems such as for scale inhibition and various pretreatments of the fluid being produced. “While the process described in '169 employs sensors in the oilfield, the general use of sensors is known. The specific use of measurement, analysis, and use of solvent-related data are not discussed in '169 which confines discussion to an “apparatus for controlling chemical injection of a surface treatment system for an oilfield well” (claim 1, col. 26, line 49).”

PCT Publication No. WO/2009/075962, to ExxonMobil Upstream Research Company, describes, according to the abstract, a method and system for estimating the status of a production well using a probability calculator and for developing such a probability calculator. The method includes developing a probability calculator, which may be a Bayesian network, utilizing the Bayesian network in a production well event detection system, which may include real-time well measurements, historical measurements, engineering judgment, and facilities data. The system also includes a display to show possible events in descending priority and/or may trigger an alarm in certain cases.

It would be desirable to use measurements of properties of the process, such as solvent production rate, in order to manage the oilfield, for instance for improving oil production or solvent efficiency.

### SUMMARY OF THE INVENTION

It is an object of the present invention to obviate or mitigate at least one disadvantage of previous methods or systems.

Described herein is the use of field measurements to manage solvent-dominated oil recovery processes, for instance for increased oil recovery and/or solvent efficiency.

Disclosed is a method of using measurement devices and analysis methodologies to address important process differences between existing thermal oil recovery systems and SDRP technologies. Also disclosed is a method of measuring and analyzing properties of a SDRP process in order to improve cycle operation or solvent usage, detect the formation of solvent fingers, or minimize solvent storage needs.

Whilst these methodologies may be carried out using analog measurement systems and traditional approaches to field management, these processes are preferably carried out using digital, remote oilfield management apparatus designed and customized for carrying out these methodologies.

Because oilfield management of a SDRP has not been carried out except for pilot-scale projects, the particular limitations of earlier disclosures cannot be appreciated except to understand how, if extended to the scale envisioned herein, those methods would not be effective. For instance, past pilots have used trucks to deliver the solvent to the field. At commercial scale, such a solvent delivery scheme may not be feasible.

In a first aspect, the present invention provides a method of managing a hydrocarbon field undergoing solvent injection, the method comprising: (a) obtaining data from sensors in the hydrocarbon field indicative of fluids produced from each of at least two wells in the hydrocarbon field; (b) using the data, estimating both the flow rate of the fluids produced from each of the at least two wells and the solvent concentration of the fluids produced from each of the at least two wells; (c) using the data, determining, for at least one of the wells, whether a solvent injection rate or a fluid production rate should be adjusted; and (d) adjusting management of the hydrocarbon field in response to the determination of step (c). In this aspect, the following features may be present. Step (d) may comprise adjusting the solvent injection rate or the fluid production rate. The estimating of step (b) may comprise calculating a sum, average, difference, variance, or ratio of data from the at least two wells. The data may comprise temperature, pressure, fluid phase fraction, flow rate, density, electrical conductivity, electrical inductance, species concentration, or more than one of the foregoing. Step (b) may comprise estimating flow behavior comprising an aqueous liquid phase rate, a gaseous phase rate, a non-aqueous liquid phase rate, a solvent rate, a hydrocarbon rate, a gas fraction, a solvent fraction, a hydrocarbon fraction, or a hydrocarbon-solvent ratio. The at least two wells may comprise at least two groups of wells, wherein the data is obtained for each of the at least two groups of wells. The method may further comprise: estimating a difference in flow behavior between the at least two wells; comparing the difference in flow behavior to a maximum acceptable value to determine whether the difference should be reduced; and where the difference is less than the set value, adjusting at least one injection or production variable to reduce the difference. The flow behavior may be solvent production rate. The method may further comprise: estimating, using the data, a solvent efficiency measure based on solvent and hydrocarbon flow rates for the at least two wells, which wells feed a solvent recycle line; and reducing solvent flow rate of a least efficient well by reducing its gross production rate. The method may further comprise using the data, adjusting the production rate of one or more of the at least two wells to reduce a difference in production flow behavior between two of the at least two wells. The solvent injection may be performed cyclically and the flow behavior may be analyzed on a cycle basis. The cycle basis may be temporally defined from a beginning of solvent injection into a well through an end of a following production period. The flow behavior may be analyzed using maximums or minimums determined over a previous time period. The flow behavior may be analyzed using net quantities. The flow behavior may be analyzed using variance measures.

In further aspect, the present invention provides a method of managing a hydrocarbon field undergoing solvent injection, the method comprising: (a) obtaining data from sensors disposed at a hydrocarbon field indicative of bottomhole pressure in each of the at least two wells; (b) using the data, estimating bottomhole pressure in each of the at least two wells; (c) using the data, determining a change in covariance of the bottom pressure between the at least two wells to determine whether a solvent connection has formed between the at least two wells; and, (d) adjusting management of the hydrocarbon field in response to the determination of step (c). In this aspect, the following features may be present. The sensors may measure bottomhole pressure. Step (d) may comprise adjusting an injection or a production rate of one or more of the at least two wells to reduce solvent flow through the connection formed between the at least two wells to increase hydrocarbon production or solvent efficiency.

In further aspect, the present invention provides a method of managing a hydrocarbon field undergoing solvent injection, the method comprising: (a) obtaining data from sensors disposed at the hydrocarbon field indicative of available solvent supply capacity; (b) using the data, estimating available solvent supply capacity; and (c) combining the estimated available solvent supply of step (b) with static data to determine whether the available solvent supply capacity is above or below a desired value, and optionally estimating by what amount. In this aspect, the following features may be present. The static data may comprise storage tank capacity, maximum solvent purchase requirement, minimum solvent purchase requirement, maximum pump injection capacity, and flowline capacity. The sensors may measure solvent supply flow rate. The method may further comprise, where the available solvent supply capacity is above the desired value, increasing total solvent injection or storing solvent on the surface; and where the available solvent supply capacity is below the desired value, decreasing total solvent injection or withdrawing solvent from surface storage. The method may further comprise, based on step (d), estimating how much solvent to purchase, or how much solvent to store in, or retrieve from, on-site storage facilities, and/or how to distribute solvent amongst two or more injection wells.

In a further aspect, the present invention provides a system for managing a hydrocarbon field undergoing solvent injection, the system comprising: (a) sensors for sensing one or more properties indicative of fluids produced from each of at least two wells; and (b) a computer system for: receiving data from the sensors; estimating both flow rate of the fluids produced from each of the at least two wells and solvent concentration of the fluids produced from each of the at least two wells; determining, using the data, for at least one of the wells, whether a solvent injection rate or a fluid production rate should be adjusted; and adjusting management of the hydrocarbon field in response to the determination.

In a further aspect, the present invention provides a system for managing a hydrocarbon field undergoing solvent injection, the system comprising: (a) sensors for sensing one or more properties indicative of fluids produced from each of at least two wells; and (b) a memory having computer readable code embodied thereon, for execution by a computer processor, for: receiving data from the sensors; estimating both flow rate of the fluids produced from each of the at least two wells and solvent concentration of the fluids produced from each of the at least two wells; determining, using the data, for at least one of the wells, whether a solvent injection rate or a fluid production rate should be adjusted; and adjusting management of the hydrocarbon field in response to the determination.

In a further aspect, the present invention provides a computer readable memory having recorded thereon statements and instructions for execution by a computer processor to carry out a method described herein.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a flow chart illustrating a method in accordance with a disclosed embodiment;

FIG. 2 is a schematic of a measurement system in accordance with a disclosed embodiment; and

FIG. 3 is another schematic of a measurement system in accordance with a disclosed embodiment.

### DETAILED DESCRIPTION

The term “viscous oil” as used herein means a hydrocarbon, or mixture of hydrocarbons, that occurs naturally and that has a viscosity of at least 10 cP (centipoise) at initial reservoir conditions. Viscous oil includes oils generally defined as “heavy oil” or “bitumen”. Bitumen is classified as an extra heavy oil, with an API gravity of about 10° or less, referring to its gravity as measured in degrees on the American Petroleum Institute (API) Scale. Heavy oil has an API gravity in the range of about 22.3° to about 10°. The terms viscous oil, heavy oil, and bitumen are used interchangeably herein since they may be extracted using similar processes.

In situ is a Latin phrase for “in the place” and, in the context of hydrocarbon recovery, refers generally to a subsurface hydrocarbon-bearing reservoir. For example, in situ temperature means the temperature within the reservoir. In another usage, an in situ oil recovery technique is one that recovers oil from a reservoir within the earth.

The term “formation” as used herein refers to a subterranean body of rock that is distinct and continuous. The terms “reservoir” and “formation” may be used interchangeably.

The expression “undergoing solvent injection” means in situ oil recovery using a SDRP. While CSDRP is discussed in certain detail, unless stated otherwise, embodiments relate to SDRP that may or may not be cyclic.

The expression “sensor” refers to any device that detects, determines, monitors, records, measures, or otherwise senses the absolute value of, or change in, a physical quantity. Non-limiting examples of measurements performed by the sensors include pressure, temperature, optical property (such as refractive index or clarity), salinity, density, viscosity, conductivity, chemical composition, force, and position. As these sensors are known in the art, they are not discussed in any detail herein.

### System Overview

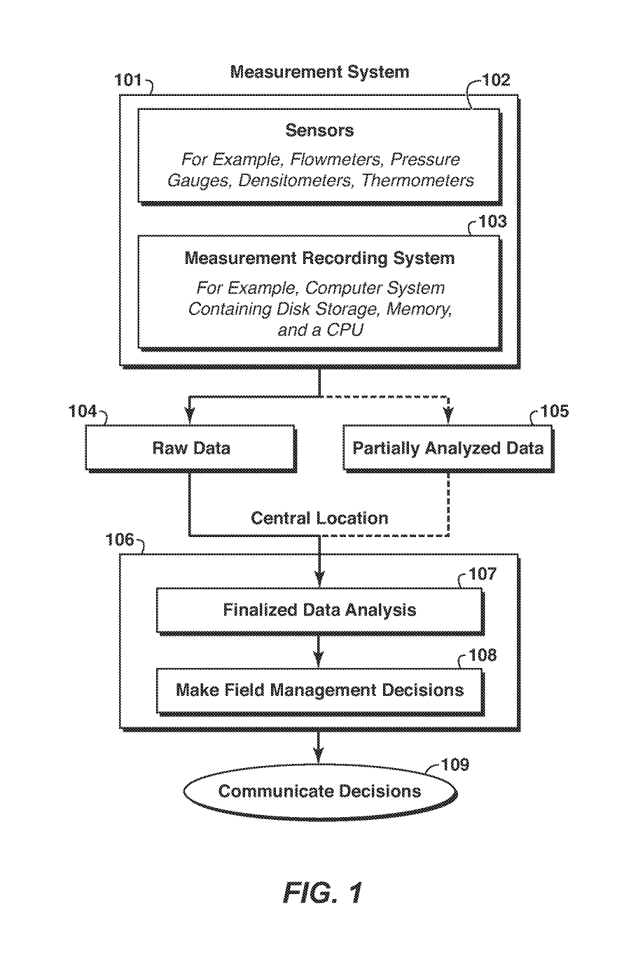

FIG. 1 depicts an overview of one embodiment. A measurement system (101) comprises sensors (102) and a measurement recording system (103). Examples of sensors include flowmeters, pressure gauges, densitometers, and thermometers. In one embodiment, the sensors include flowmeters and pressure gauges. An example of a measurement recording system (103) is a computer system comprising the ability to receive, store, and at least partially analyze data from the sensors, and to provide access to the data, or the at least partially analyzed data.

The data are in digital form as either data (104) or partially analyzed data (105). Examples of data include raw, compressed, filtered, or subsets of the data. Examples of partially analyzed data include rounded data, sums, averages, maximums, minimums, variance measures, net quantities, or other products of mathematical operators.

The data or partially analyzed data are retrievable by a central location (106), preferably using electronic means, and more preferably using real-time or near real-time transmission. In this context, real-time means continuously streaming and near real-time means a transmission frequency of at least daily. At the central location, the data analysis is finalized (107) and used to make a field management decision (108) which is subsequently communicated to the field (109).

The expression “sensors disposed at the oil field” includes sensors in the facilities associated with the oil field.

Described below are embodiments relating to managing a SDRP.

### Solvent Rate Measurement System

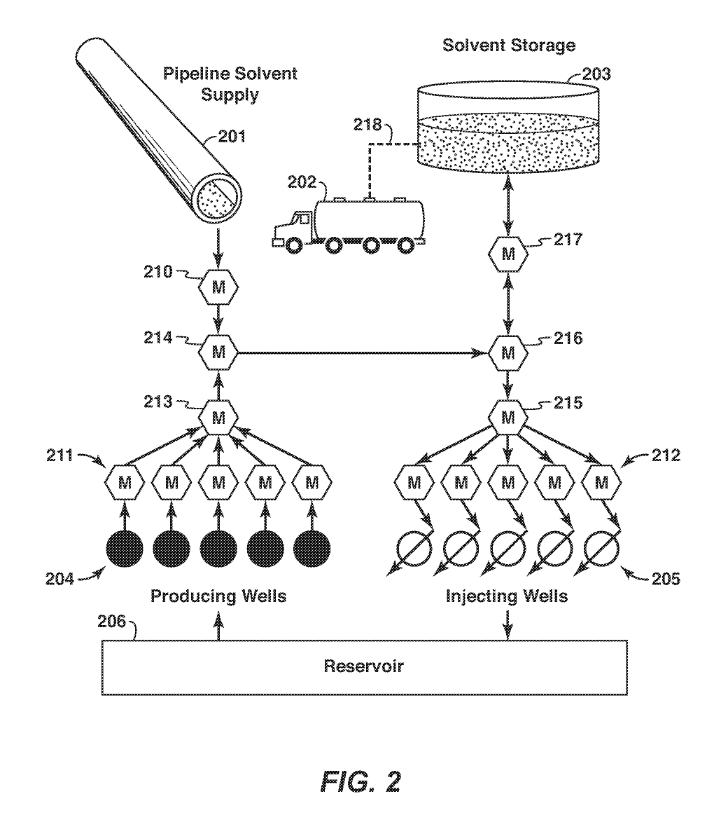

FIG. 2 depicts the solvent flowstreams of one embodiment of a SDRP. The SDRP in this embodiment employs a pipeline (201) to supply solvent, trucked-in solvent supply (202), one or more solvent storage tank(s) (203), one or more producing wells (204), one or more injecting wells (205), a subterranean reservoir (206), and flow lines and measurement devices connecting them. For the sake of artistic convenience, FIG. 2 illustrates five producers, five injectors, one reservoir, one pipeline, and one tank. Those skilled in the art will recognize conceivable alternatives such as dispensing with one or more elements, such as the trucked solvent (202), pipelined solvent (pipeline 201), tank(s) (203), some portion of the measurement system (210 to 217), or other permutations of flowline connectivity. Those skilled in the art will recognize conceivable alternatives such as adding additional elements, such as additional reservoirs (206), trucks (202), or tanks (203), or measurement locations, to name but a few.

FIG. 2 shows that measurement devices (“measurement devices” is used interchangeably with “sensors”), denoted “M”, are affixed to various strategic locations in the flowline system. The measurement devices record the rate of pipelined solvent supply (210), the producing wells' solvent production rates (211), the injecting wells' solvent injection rates (212), the total produced solvent supply (213), the combined pipelined and produced solvent supply (214), the total injected solvent rate (215), the combined available solvent supply (216), the flow rate to or from storage (217), and the intermittent (intermittent nature denoted with dashed line) trucked-in solvent supply rate (218). While measurements of rate have been discussed, measurements of pressure, density, and temperature, for example, may also, or alternatively, be made.

In order to measure solvent rates from fluid streams that comprise fluid mixtures, separation processes or concentration measurement may be required. Measurement in portions of the produced fluids system is also therefore employed to achieve the measurements envisioned in FIG. 2.

### Produced Fluid Measurement System

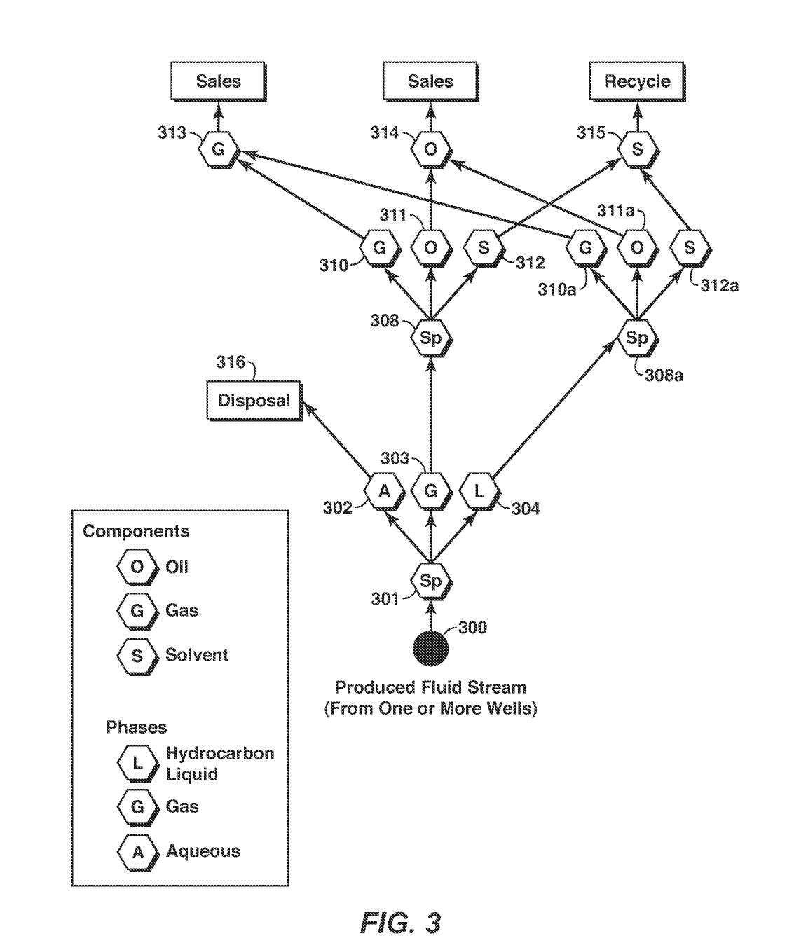

FIG. 3 depicts one embodiment of a produced fluids measurement system for a SDRP. The produced fluid (300) from one or more wells is separated using a separator (Sp) (301) into aqueous (302), gaseous (303), and liquid hydrocarbon (304) phases. The aqueous stream (302) is disposed of (316). The gaseous flowstream (303) is further separated, using separator (Sp) (308) into its components, natural gas (310), oil (311), and solvent (312). The liquid hydrocarbon flowstream (304) is further separated into its components, natural gas (310a), oil (311a), and solvent (312a) using separator (Sp) (308a). The component streams are recombined. The separation processes need not be one hundred percent efficient. For example, it is acceptable to have concentrations (for example, no more than a few mass percent) of solvent remaining in the oil phase, and vice versa.

The combined gaseous stream (313) and oil stream (314) may be sold. In this embodiment, the combined solvent stream (315) is recycled as a flowstream shown in FIG. 2 (213). The precise destination of the combined produced solvent stream (315) depends upon the lifecycle phase of the SDRP oilfield development. During the ramp-up of the field development all of the produced solvent may be recycled as injected solvent (213). During the wind-down of the SDRP-produced oilfield, a portion of the produced solvent may be recycled as injected solvent and the remaining portion sold. When all solvent injection in the oilfield has ceased, all of the produced solvent may be sold.

It is not typical oilfield practice to carry out continuous separation of the individual flow streams for every well—they are usually combined at a manifold into one fluid stream (300) prior to separation. However, the instant process makes use of component and phase flow rates for individual wells. In the described process, the frequency of these measurements need not be continuous. For example, a test separator could be used on a daily basis to measure the individual phase (302, 303, 304) and component (310, 311, 312) flow rates for every well. Understanding the solvent and oil production rates for a well undergoing a SDRP is important for maximizing performance.

The produced fluid measurement system may also have devices to control field operations such as valves, pumps, and other fluid control devices. Common fluid control devices include valves to choke flow, rotary pumps, and programmable logic controllers. Programmable logic controllers may use a measurement from the produced fluid measurement system in order to automatically control a valve, a pump, or other fluid control device.

### Substantially Time Varying Measurements

The measurement systems described in FIGS. 2 and 3 are meant to capture primarily time varying data. For reasons of both convenience and scientific merit, it is commonplace to process the raw, measured, time-varying data. As used herein, the term “analyzed data” is used interchangeably with “products of mathematical operators.” These quantities are computed from time-dependent variables and change with time. Such measures may be computed over a period of time. For example, a running average is an example of analyzed data derived through mathematical operation on a time series variable. Examples of partially analyzed data include rounded data, filtered (decimated) data, sums, averages, ratios, maximums, minimums, variance measures, net quantities, or other products of mathematical operators.

A particular way to aggregate time varying data that is useful for analyzing cyclic SDRPs (CSDRPs) is to compute averages or sums on a cycle basis. For example, computations of solvent efficiency require a measurement of oil production per solvent volume. One measure is the produced oil to injected solvent ratio, or OISR. This computation is carried out by computing the volume of oil obtained from a well during the production phase of a cycle and dividing it by the volume of solvent injected during the injection phase of the same cycle. An important economic choice in CSDRPs is whether or not to carry out another injection cycle; once the injection phase of the cycle is over, there is little additional cost to complete the cycle. In a SDRP that is not a CSDRP, a solvent efficiency measure that is not cycle-based may be appropriate, for example a weekly calculated OISR.

### Substantially Non-Time Varying Measurements

As used herein, the terms “static data”, “constraints”, “system parameters”, and “facilities data” refer generally to related values that do not change continuously over time and remain fixed for a substantial portion of the SDRP. For example, the state of the choke on a flow line remains fixed in one position and does not change until it is fixed in a different position by an operator. These kinds of data are discrete and typically associated with some facility. System parameters that seldom vary with time include, by way of example, storage tank capacity, maximum and minimum solvent purchase requirements, maximum pump injection capacity, flowline capacity, and other system operational limits or setpoints. While different SDRP systems are subject to different constraints and the same system may be subject to different constraints at different times, all SDRP systems have substantially non-time varying data that are important for efficiently using solvent.

### Data Access

Although the methodology described could be carried out using traditional field-based methods, such as storing the measurements in a written or electronic file and transporting them to persons who analyze them and make field management decisions, the process is optimally practiced using remote monitoring of the measurements. For example, it is preferable that field staff carry out the measurement procedures by maintaining and operating the equipment that is used to obtain, store, and provide access to (and optionally to transmit) the measurements to engineers based outside the field, for example in an office.

### Specific Examples of how the Process May be Used to Accomplish a Valuable Result

The digital oilfield management and measurement system just described may be used to adjust production rates of one or more wells to reduce the difference in production flow behavior of at least two production wells. Flow behavior may include all of the measurements discussed thus far and includes quantities such as phase and component flow rates. For example, the solvent production rate is one kind of flow behavior. Another kind of flow behavior is the total production rate. It is desirable to control the flow behavior of the solvent in particular because of its economic value since it is typically more valuable than the produced oil.

One difference in flow behavior might be a difference in gas production between at least two production wells. SDRP wells may produce both native gases and solvent gas depending upon the operating pressure and reservoir fluid characteristics. Gas production is oftentimes detrimental to oil recovery, and natural gas production in particular is undesirable as it may signal the bypassing of oil and is less valuable than solvent gas. The fraction of gas (native or solvent) in the produced stream may be computed by measuring the gas production stream (303) in relation to the other production streams (302, 304). If the gas fraction rises too high, the producing bottomhole pressure could be raised in an attempt to prevent gas breakthrough. When a SDRP is producing at pressures below the vapor pressure of the solvent, it is expected that solvent gas will be produced. The recovery of solvent gas is required for SDRPs to be economic. Distinguishing between native gas and solvent gas is therefore important. The measurement system is preferably designed to distinguish between the two, as does the measurement system of FIG. 3.

Another difference in flow behavior between two or more wells might be the solvent production rate. The capacity of the flowline carrying the combined pipelined and produced solvent supply (214) is necessarily of limited capacity. If it were to reach maximum capacity, it would be desirable to choke back, or decrease, the flow rate of solvent from the wells with the lowest solvent efficiency. The wells have differential solvent production rates and it is desirable to know which wells should be choked back. To accomplish this desired flow reduction the following may be carried out: (1) calculate a solvent efficiency measure using the solvent and oil flow rates for every well that feeds the solvent recycle line; (2) rank all the wells from most to least solvent efficient; and (3) reduce the solvent flow rate of the least efficient well by reducing its gross production rate. Gross production rate may be decreased by increasing the producing pressure of the well.

Cyclic SDRPs in particular should make use of measures of solvent efficiency to decide when to switch from production to injection. Using an embodiment of the instant invention, the field management decision of when to switch from production to injection could be carried out using these steps: (1) measure and transmit a well's solvent and oil produced volumes to a central office on a near real-time basis; (2) calculate solvent efficiency measures such as oil to solvent ratio on a cycle basis; (3) if the well is no longer as efficient as desired, switch to production or initiate other action; and (4) communicate decision to field.

The supply rate of the pipeline (201) is necessarily of limited capacity and also of preferably constant rate within some contractually specified variation. In order to stay within the specified downside variation, it is necessary to increase injection of solvent into wells or store solvent. To accomplish this control, the following may be carried out: (1) measure the flowrate (210) of the supply and determine if the flowrate is nearing the downside limit or the upside limit; (2) if the flowrate is nearing the downside limit, then increase total injection to the reservoir (206) or store solvent on the surface (for example, surface tank(s) 203); and (3) if the flowrate is nearing the upside limit, then decrease total injection to the reservoir (206) or withdraw solvent from the surface tank(s) (203).

In CSDRPs, as solvent is injected into the formation, solvent fingers form which can, relatively early in the life of the field, stretch out 100 meters or more and connect up with other wells. If the well injection and production cycles are not sufficiently synchronized, solvent may rapidly flow from one well to the other when one is on production and the other is on injection and have a negative impact on solvent efficiency and consequent oil recovery. Such orientation is notable because two nearby wells will experience injector-to-producer channeling of injected solvent if they are operated out-of-phase. Even though injected solvent and injected steam both have adverse mobility ratios when injected into highly viscous oil, the channeling effect is particularly acute in solvent-dominated processes, more so than in steam-based processes, and more so than is generally appreciated by those skilled in the art.

Two nearby wells may experience injector-to-producer channeling of injected solvent if they are operated out-of-synch, where one well is injecting while the other is producing. Channeling leads to fluid communication. Fluid communication between two neighboring wells is said to have occurred when a pressure change recorded at one well is also detectable at a neighboring well. The stronger the correlation in the pressure changes, the stronger the communication. Two wells in fluid communication are said to be “connected”. A change in pressure covariance between two or more wells may indicate the formation of a solvent channel between the two or more wells. If covariance is detected, the two wells can be operated substantially in-synch such that the wells are operated either both on injection or both on production, but not opposite. Referring to FIG. 1, another way to accomplish communication reduction is to transmit the pressure data in raw (104) or partially filtered or decimated form (105) to a central office (106) were the data is analyzed for covariance (107) and a decision is made (108) to, for example, decrease the injection rate at one of the two wells.

Reducing the amount of solvent stored on-site is important because solvent storage is expensive. Envisioned solvents, such as light hydrocarbons, must be stored at high pressure in order to be a liquid and therefore storable in a tank. High-pressure storage is more expensive than storage at atmospheric pressure because the tank walls must be thicker than for the equivalent volume at atmospheric pressure. Transmission of the amount of solvent in storage, in combination with knowledge of the tank volume, allows calculation of the tank ullage. Operators planning the dispatch of a solvent delivery truck or planning for an injection rate increase can operate more efficiently with real-time knowledge of the tank ullage. The tank is spare solvent injection supply and accurate, remote knowledge of the current spare capacity (the current solvent volume in the tank) enables the tank to be refilled just-in-time. This mitigates the need to build the tank larger than is truly needed.

### Solvent Composition

The solvent may be a light, but condensable, hydrocarbon or mixture of hydrocarbons comprising ethane, propane, or butane. Additional injectants may include CO₂, natural gas, C₃₊ hydrocarbons, ketones, and alcohols. Non-solvent co-injectants may include steam, hot water, or hydrate inhibitors. Viscosifiers may be useful in adjusting solvent viscosity to reach desired injection pressures at available pump rates and may include diesel, viscous oil, bitumen, or diluent. Viscosifiers may also act as solvents and therefore may provide flow assurance near the wellbore and in the surface facilities in the event of asphaltene precipitation or solvent vaporization during shut-in periods. Carbon dioxide or hydrocarbon mixtures comprising carbon dioxide may also be desirable to use as a solvent.

In one embodiment, the solvent comprises greater than 50% C₂-C₅ hydrocarbons on a mass basis. In one embodiment, the solvent is primarily propane, optionally with diluent when it is desirable to adjust the properties of the injectant to improve performance. Alternatively, wells may be subjected to compositions other than these main solvents to improve well pattern performance, for example CO₂ flooding of a mature operation.

### Phase of Injected Solvent

In one embodiment, the solvent is injected into the well at a pressure in the underground reservoir above a liquid/vapor phase change pressure such that at least 25 mass % of the solvent enters the reservoir in the liquid phase. Alternatively, at least 50, 70, or even 90 mass % of the solvent may enter the reservoir in the liquid phase. Injection as a liquid may be preferred for achieving high pressures because pore dilation at high pressures is thought to be a particularly effective mechanism for permitting solvent to enter into reservoirs filled with viscous oils when the reservoir comprises largely unconsolidated sand grains. Injection as a liquid also may allow higher overall injection rates than injection as a gas.

In an alternative embodiment, the solvent volume is injected into the well at rates and pressures such that immediately after halting injection into the injection well at least 25 mass % of the injected solvent is in a liquid state in the underground reservoir. Injection as a vapor may be preferred in order to enable more uniform solvent distribution along a horizontal well. Depending on the pressure of the reservoir, it may be desirable to significantly heat the solvent in order to inject it as a vapor. Heating of injected vapor or liquid solvent may enhance production through mechanisms described by “Boberg, T. C. and Lantz, R. B., “Calculation of the production of a thermally stimulated well”, JPT, 1613-1623, December 1966. Towards the end of an injection cycle, a portion of the injected solvent, perhaps 25% or more, may become a liquid as pressure rises. Because no special effort is made to maintain the injection pressure at the saturation conditions of the solvent, liquefaction would occur through pressurization, not condensation. Downhole pressure gauges and/or reservoir simulation may be used to estimate the phase of the solvent and other co-injectants at downhole conditions and in the reservoir. A reservoir simulation is carried out using a reservoir simulator, a software program for mathematically modeling the phase and flow behavior of fluids in an underground reservoir. Those skilled in the art understand how to use a reservoir simulator to determine if 25% of the injectant would be in the liquid phase immediately after halting injection. Those skilled in the art may rely on measurements recorded using a downhole pressure gauge in order to increase the accuracy of a reservoir simulator. Alternatively, the downhole pressure gauge measurements may be used to directly make the determination without the use of reservoir simulation.

Although preferably a SDRP is predominantly a non-thermal process in that heat is not used principally to reduce the viscosity of the viscous oil, the use of heat is not excluded. Heating may be beneficial to improve performance, improve process start-up, or provide flow assurance during production. For start-up, low-level heating (for example, less than 100° C.) may be appropriate. Low-level heating of the solvent prior to injection may also be performed to prevent hydrate formation in tubulars and in the reservoir. Heating to higher temperatures may benefit recovery.

Table 1 outlines the operating ranges for CSDRPs of some embodiments. The present invention is not intended to be limited by such operating ranges.

TABLE 1
Operating Ranges for a CSDRP.

| Parameter | Broader Embodiment | Narrower Embodiment |
|---|---|---|
| Injectant volume | Fill-up estimated pattern pore | Inject, beyond a pressure |
| | volume plus 2-15% of | threshold, 2-15% (or 3-8%) of |
| | estimated pattern pore volume; | estimated pore volume. |
| | or inject, beyond a pressure | |
| | threshold, for a period of time | |
| | (e.g. weeks to months); or | |
| | inject, beyond a pressure | |
| | threshold, 2-15% of estimated | |
| | pore volume. | |
| Injectant | Main solvent (>50 mass %) C₂- | Main solvent(>50 mass %)is |
| composition, | C₅. Alternatively, wells may be | propane (C₃). |
| main | subjected to compositions | |
| | other than main solvents to | |
| | improve well pattern | |
| | performance (i.e. CO₂ flooding | |
| | of a mature operation or | |
| | altering in-situ stress of | |
| | reservoir). | |
| Injectant | Additional injectants may | Only diluent, and only when |
| composition, | include CO₂ (up to about 30%), | needed to achieve adequate |
| additive | C₃₊, viscosifiers (e.g. diesel, | injection pressure. |
| | viscous oil, bitumen, diluent), | |
| | ketones, alcohols, sulphur | |
| | dioxide, hydrate inhibitors, and | |
| | steam. | |
| Injectant phase & | Solvent injected such that at | Solvent injected as a liquid, and |
| Injection pressure | the end of injection, greater | most solvent injected just under |
| | than 25% by mass of the | fracture pressure and above |
| | solvent exists as a liquid in the | dilation pressure, |
| | reservoir, with no constraint as | Pfracture > Pinjection > Pdilation > |
| | to whether most solvent is | PvaporP. |
| | injected above or below | |
| | dilation pressure or fracture | |
| | pressure. | |
| Injectant | Enough heat to prevent | Enough heat to prevent hydrates |
| temperature | hydrates and locally enhance | with a safety margin, |
| | wellbore inflow consistent with | Thydrate + 5° C. to |
| | Boberg-Lantz mode | Thydrate + 50° C. |
| Injection rate | 0.1 to 10 m³/day per meter of | 0.2 to 2 m³/day per meter of |
| | completed well length (rate | completed well length (rate |
| | expressed as volumes of liquid | expressed as volumes of liquid |
| | solvent at reservoir conditions). | solvent at reservoir conditions). |
| | | Rates may also be designed to |
| | | allow for limited or controlled |
| | | fracture extent, at fracture |
| | | pressure or desired solvent |
| | | conformance depending on |
| | | reservoir properties. |
| Threshold | Any pressure above initial | A pressure between 90% and |
| pressure | reservoir pressure. | 100% of fracture pressure. |
| (pressure at which | | |
| solvent continues | | |
| to be injected for | | |
| either a period of | | |
| time or in a volume | | |
| amount) | | |
| Well length | As long of a horizontal well as | 500 m-1500 m (commercial well). |
| | can practically be drilled; or the | |
| | entire pay thickness for vertical | |
| | wells. | |
| Well | Horizontal wells parallel to | Horizontal wells parallel to each |
| configuration | each other, separated by some | other, separated by some regular |
| | regular spacing of 60-600 m; | spacing of 60-320 m. |
| | Also vertical wells, high angle | |
| | slant wells & multi-lateral wells. | |
| | Also infill injection and/or | |
| | production wells (of any type | |
| | above) targeting bypassed | |
| | hydrocarbon from surveillance | |
| | of pattern performance. | |
| Well orientation | Orientated in any direction. | Horizontal wells orientated |
| | | perpendicular to (or with less than |
| | | 30 degrees of variation) the |
| | | direction of maximum horizontal |
| | | in-situ stress. |
| Minimum | Generally, the range of the | A low pressure below the vapor |
| producing | MPP should be, on the low | pressure of the main solvent, |
| pressure (MPP) | end, a pressure significantly | ensuring vaporization, or, in the |
| | below the vapor pressure, | limited vaporization scheme, a |
| | ensuring vaporization; and, on | high pressure above the vapor |
| | the high-end, a high pressure | pressure. At 500 m depth with pure |
| | near the native reservoir | propane, 0.5 MPa (low)-1.5 MPa |
| | pressure. For example, | (high), values that bound the |
| | perhaps 0.1 MPa-5 MPa, | 800 kPa vapor pressure of |
| | depending on depth and mode | propane. |
| | of operation (all-liquid or limited | |
| | vaporization). | |
| Oil rate | Switch to injection when rate | Switch when the instantaneous oil |
| | equals 2 to 50% of the max | rate declines below the calendar |
| | rate obtained during the cycle; | day oil rate (CDOR) (e.g. total |
| | Alternatively, switch when | oil/total cycle length). Likely most |
| | absolute rate equals a pre-set | economically optimal when the oil |
| | value. Alternatively, well is | rate is at about 0.8 × CDOR. |
| | unable to sustain hydrocarbon | Alternatively, switch to injection |
| | flow (continuous or | when rate equals 20-40% of the |
| | intermittent) by primary | max rate obtained during the |
| | production against back- | cycle. |
| | pressure of gathering system | |
| | or well is “pumped off” unable | |
| | to sustain flow from artificial lift. | |
| | Alternatively, well is out of sync | |
| | with adjacent well cycles. | |
| Gas rate | Switch to injection when gas | Switch to injection when gas rate |
| | rate exceeds the capacity of | exceeds the capacity of the |
| | the pumping or gas venting | pumping or gas venting system. |
| | system. Well is unable to | During production, an optimal |
| | sustain hydrocarbon flow | strategy is one that limits gas |
| | (continuous or intermittent) by | production and maximizes liquid |
| | primary production against | from a horizontal well. |
| | backpressure of gathering | |
| | system with/or without | |
| | compression facilities. | |
| Oil to Solvent | Begin another cycle if the | Begin another cycle if the OISR of |
| Ratio | OISR of the just completed | the just completed cycle is above |
| | cycle is above 0.15 or | 0.3. |
| | economic threshold. | |
| Abandonment | Atmospheric or a value at | For propane and a depth of 500 m, |
| pressure | which all of the solvent is | about 340 kPa, the likely lowest |
| (pressure at | vaporized. | obtainable bottomhole pressure at |
| which well is | | the operating depth and well |
| produced after | | below the value at which all of the |
| CSDRP cycles | | propane is vaporized. |
| are completed) | | |

In Table 1, embodiments may be formed by combining two or more parameters and, for brevity and clarity, each of these combinations will not be individually listed.

In the context of this specification, diluent means a liquid compound that can be used to dilute the solvent and can be used to manipulate the viscosity of any resulting solvent-bitumen mixture. By such manipulation of the viscosity of the solvent-bitumen (and diluent) mixture, the invasion, mobility, and distribution of solvent in the reservoir can be controlled so as to increase viscous oil production.

The diluent is typically a viscous hydrocarbon liquid, especially a C₄ to C₂₀ hydrocarbon, or mixture thereof, is commonly locally produced and is typically used to thin bitumen to pipeline specifications. Pentane, hexane, and heptane are commonly components of such diluents. Bitumen itself can be used to modify the viscosity of the injected fluid, often in conjunction with ethane solvent.

In certain embodiments, the diluent may have an average initial boiling point close to the boiling point of pentane (36° C.) or hexane (69° C.) though the average boiling point (defined further below) may change with reuse as the mix changes (some of the solvent originating among the recovered viscous oil fractions). Preferably, more than 50% by weight of the diluent has an average boiling point lower than the boiling point of decane (174° C.). More preferably, more than 75% by weight, especially more than 80% by weight, and particularly more than 90% by weight of the diluent, has an average boiling point between the boiling point of pentane and the boiling point of decane. In further preferred embodiments, the diluent has an average boiling point close to the boiling point of hexane (69° C.) or heptane (98° C.), or even water (100° C.).

In additional embodiments, more than 50% by weight of the diluent (particularly more than 75% or 80% by weight and especially more than 90% by weight) has a boiling point between the boiling points of pentane and decane. In other embodiments, more than 50% by weight of the diluent has a boiling point between the boiling points of hexane (69° C.) and nonane (151° C.), particularly between the boiling points of heptane (98° C.) and octane (126° C.).

By average boiling point of the diluent, we mean the boiling point of the diluent remaining after half (by weight) of a starting amount of diluent has been boiled off as defined by ASTM D 2887 (1997), for example. The average boiling point can be determined by gas chromatographic methods or more tediously by distillation. Boiling points are defined as the boiling points at atmospheric pressure.

In the preceding description, for purposes of explanation, numerous details are set forth in order to provide a thorough understanding of the embodiments of the invention. However, it will be apparent to one skilled in the art that these specific details are not required in order to practice the invention.

Embodiments of the invention can be represented as a software product stored in a machine-readable medium (also referred to as a computer-readable medium, a processor-readable medium, or a computer usable medium having a computer-readable program code embodied therein). The machine-readable medium can be any suitable tangible medium that may be processed by a computer to perform the steps developed in this invention, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention can also be stored on the machine-readable medium. Software running from the machine-readable medium can interface with circuitry to perform the described tasks.

The above-described embodiments of the invention are intended to be examples only. Alterations, modifications and variations can be effected to the particular embodiments by those of skill in the art without departing from the scope of the invention, which is defined solely by the claims appended hereto.

What is claimed is:

1. A method of managing a hydrocarbon field undergoing solvent injection, the method comprising:
(a) obtaining data from sensors in the hydrocarbon field indicative of fluids produced from each of at least two wells in the hydrocarbon field;
(b) using the data, estimating both flow rate of the fluids produced from each of the at least two wells and solvent concentration of the fluids produced from each of the at least two wells;
(c) using the data, determining, for at least one of the wells, whether a solvent injection rate or a fluid production rate should be adjusted; and
(d) adjusting management of the hydrocarbon field in response to the determination of step (c).

2. The method of claim 1 wherein step (d) comprises adjusting the solvent injection rate or the fluid production rate.

3. The method of 1 wherein the estimating of step (b) comprises calculating a sum, average, difference, variance, or ratio, of data from the at least two wells.

4. The method of any one of claim 1 wherein the data comprises temperature, pressure, fluid phase fraction, flow rate, density, electrical conductivity, electrical inductance, species concentration, or more than one of the foregoing.

5. The method of claim 1 wherein step (b) comprises estimating flow behavior comprising an aqueous liquid phase rate, a gaseous phase rate, a non-aqueous liquid phase rate, a solvent rate, a hydrocarbon rate, a gas fraction, a solvent fraction, a hydrocarbon fraction, or a hydrocarbon-solvent ratio.

6. The method of claim 1 wherein the at least two wells comprises at least two groups of wells, wherein the data is obtained for each of the at least two groups of wells.

7. The method of claim 5 wherein the method further comprises:
estimating a difference in flow behavior between the at least two wells;
comparing the difference in flow behavior to a maximum acceptable value to determine whether the difference should be reduced; and
where the difference is less than the set value, adjusting at least one injection or production variable to reduce the difference.

8. The method of claim 7 wherein the flow behavior is solvent production rate.

9. The method of claim 1 further comprising:
estimating, using the data, a solvent efficiency measure based on solvent and hydrocarbon flow rates for the at least two wells, which wells feed a solvent recycle line; and
reducing solvent flow rate of a least efficient well by reducing its gross production rate.

10. The method of claim 1 further comprising, using the data, adjusting the production rate of one or more of the at least two wells to reduce a difference in production flow behavior between two of the at least two wells.

11. The method of claim 5 wherein the solvent injection is performed cyclically and the flow behavior is analyzed on a cycle basis.

12. The method of claim 11 wherein the cycle basis is temporally defined from a beginning of solvent injection into a well through an end of a following production period.

13. The method of claim 5 wherein the flow behavior is analyzed using maximums or minimums determined over a previous time period.

14. The method of claim 5 wherein the flow behavior is analyzed using net quantities.

15. The method of claim 5 wherein the flow behavior is analyzed using variance measures.

16. A method of managing a hydrocarbon field undergoing solvent injection, the method comprising:
(a) obtaining data from sensors disposed at a hydrocarbon field indicative of bottomhole pressure in each of the at least two wells;
(b) using the data, estimating bottomhole pressure in each of the at least two wells;
(c) using the data, determining a change in covariance of the bottom pressure between the at least two wells to determine whether a solvent connection has formed between the at least two wells; and,
(d) adjusting management of the hydrocarbon field in response to the determination of step (c).

17. The method of claim 16 wherein the sensors measure bottomhole pressure.

18. The method of claim 16 wherein step (d) comprises adjusting an injection or a production rate of one or more of the at least two wells to reduce solvent flow through the connection formed between the at least two wells to increase hydrocarbon production or solvent efficiency.

19. A method of managing a hydrocarbon field undergoing solvent injection, the method comprising:
(a) obtaining data from sensors disposed at the hydrocarbon field indicative of available solvent supply capacity;
(b) using the data, estimating available solvent supply capacity; and
(c) combining the estimated available solvent supply capacity of step (b) with static data to determine whether the available solvent supply capacity is above or below a desired value, and optionally estimating by what amount.

20. The method of claim 19 wherein the static data comprises storage tank capacity, maximum solvent purchase requirement, minimum solvent purchase requirement, maximum pump injection capacity, and flowline capacity.

21. The method of claim 19 wherein the sensors measure solvent supply flow rate.

22. The method of claim 21 further comprising:
where the available solvent supply capacity is above the desired value, increasing total solvent injection or storing solvent on the surface; and
where the available solvent supply capacity is below the desired value, decreasing total solvent injection or withdrawing solvent from surface storage.

23. The method of claim 19 further comprising, based on step (d), estimating how much solvent to purchase, or how much solvent to store in, or retrieve from, on-site storage facilities, and/or how to distribute solvent amongst two or more injection wells.

24. The method of claim 1 wherein the method is performed on a real-time or near real-time basis.

25. The method of claim 1 wherein the hydrocarbon is viscous oil having a viscosity of greater than 10 cP at initial reservoir conditions.

26. The method of claim 1 wherein the hydrocarbon field undergoing solvent injection is a hydrocarbon field undergoing a cyclic solvent-dominated recovery process.

27. The method of claim 1 wherein at least 25 mass % of the solvent enters an underground hydrocarbon reservoir of the hydrocarbon field as a liquid.

28. The method of claim 1 wherein at least 50 mass % of the solvent enters an underground hydrocarbon reservoir of the hydrocarbon field as a liquid.

29. The method of claim 26 wherein immediately after halting injection of the solvent, at least 25 mass % of the solvent is in a liquid state in an underground hydrocarbon reservoir of the hydrocarbon field.

30. The method of claim 26 wherein injection and production are effected using a common wellbore.

31. The method of claim 1 wherein at least 25 mass % of the solvent enters an underground hydrocarbon reservoir of the hydrocarbon field as a vapor.

32. The method of claim 1 wherein the solvent comprises ethane, propane, butane, pentane, carbon dioxide, or a combination thereof.

33. The method of claim 1 wherein the solvent comprises greater than 50 mass % propane.

34. The method of claim 1 wherein the at least two wells form a well group.

35. The method of claim 1 performed digitally using a computer processor.

36. A system for managing a hydrocarbon field undergoing solvent injection, the system comprising:
(a) sensors for sensing one or more properties indicative of fluids produced from each of at least two wells; and
(b) a computer system for:
receiving data from the sensors;
estimating both flow rate of the fluids produced from each of the at least two wells and solvent concentration of the fluids produced from each of the at least two wells;
determining, using the data, for at least one of the wells, whether a solvent injection rate or a fluid production rate should be adjusted; and
adjusting management of the hydrocarbon field in response to the determination.

37. A system for managing a hydrocarbon field undergoing solvent injection, the system comprising:
(a) sensors for sensing one or more properties indicative of fluids produced from each of at least two wells; and
(b) a memory having computer readable code embodied thereon, for execution by a computer processor, for:
receiving data from the sensors;
estimating both flow rate of the fluids produced from each of the at least two wells and solvent concentration of the fluids produced from each of the at least two wells;
determining, using the data, for at least one of the wells, whether a solvent injection rate or a fluid production rate should be adjusted; and
adjusting management of the hydrocarbon field in response to the determination.

38. A computer readable memory having recorded thereon statements and instructions for execution by a computer processor to carry out the method of claims 1.
